(19) United States
(12) Patent Application Publication
(10) Pub. No.: US 2016/0135049 A1
(43) Pub. Date: May 12, 2016

(54) TECHNIQUES FOR MANAGING SERVICES FOLLOWING AN AUTHENTICATION FAILURE IN A WIRELESS COMMUNICATION SYSTEM

(71) Applicant: QUALCOMM Incorporated, San Diego, CA (US)

(72) Inventors: Ankit BANAUDHA, San Diego, CA (US); Zhong Ren, San Diego, CA (US); Lenaig Chaponniere, La Jolla, CA (US); Cogol Tina, Mission Viejo, CA (US); Arvind Santhanam, San Diego, CA (US); Vitaly Drapkin, San Diego, CA (US)

(21) Appl. No.: 14/928,899

(22) Filed: Oct. 30, 2015

Related U.S. Application Data
(60) Provisional application No. 62/077,114, filed on Nov. 7, 2014.

(51) Int. Cl. H04W 12/06; H04W 76/06

(52) U.S. Cl. CPC H04W 12/06; H04W 76/06

(57) ABSTRACT

Various aspects described herein relate to establishing services in wireless communications. A service request related to establishing a service over an established radio bearer can be transmitted. An authentication failure for the service request can be detected. It can be determined whether a procedure related to the service request is successfully completed. In can also be determined whether to terminate the established radio bearer based at least in part on the determination of whether the procedure related to the service request is successfully completed.

### CLAIM OF PRIORITY UNDER 35 U.S.C. §119

The present Application for Patent claims priority to Provisional Application No. 62/077,114 entitled “TECHNIQUES FOR MANAGING SERVICES FOLLOWING AN AUTHENTICATION FAILURE IN A WIRELESS COMMUNICATION SYSTEM” filed Nov. 7, 2014, which is assigned to the assignee hereof and hereby expressly incorporated by reference herein.

### FIELD OF DISCLOSURE

Described herein are aspects generally related to communication systems, and more particularly, to techniques for managing services based on an authentication failure in a wireless communication system.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of a telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology.

In wireless communication systems employing LTE, a user equipment (UE) can perform a service request to a network over an established bearer to request certain services (e.g., a non-access stratum request). In response, the network can request authentication for the service, and the authentication may fail at the UE, which the UE can indicate to the network. In addition, the UE can initialize an authentication failure timer based on the authentication failure, where if the authentication failure timer expires before authentication with the network succeeds, the UE initializes a non-access stratum request timer after expiration of which the service request for the service is rejected and/or the established bearer is terminated. For certain services (such as emergency calls), however, the network may allow the service to be established without authentication. Even when such services are established, however, UEs currently initialize the authentication failure and/or service request retransmission timers, which may result in termination of the established bearer and disruption of the established services.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect, a method for establishing services in wireless communications is provided. The method may include transmitting a service request related to establishing a service over an established radio bearer, detecting an authentication failure for the service request, determining whether a procedure related to the service request is successfully completed, and determining whether to terminate the established radio bearer based at least in part on the determination of whether the procedure related to the service request is successfully completed.

The method may also include determining whether to terminate the established radio bearer, which may include determining whether to start a service request retransmission timer after expiration of which the established radio bearer is terminated. The method may further include determining whether to start the service request retransmission timer, which may occur based on an expiration of an authentication failure timer initialized based on detecting the authentication failure. Also, the method may include determining whether to start the service request retransmission timer, which may include determining not to start the service request retransmission timer based on the expiration of the authentication failure timer where it is determined that the procedure related to the service request is successfully completed. The method may further include determining whether to start the service request retransmission timer, which may include determining to start the service request retransmission timer based on the expiration of the authentication failure timer where it is determined that the procedure related to the service request is not successfully completed. Additionally, the method may include determining whether the procedure related to the service request is successfully completed, which may include determining whether the procedure related to the service request is successfully completed before the expiration of the authentication failure timer. The service request retransmission timer may be a T3417 timer in third generation partnership project (3GPP) long term evolution (LTE) related to retransmission of the service request.

Also, the method may include detecting the authentication failure for the service request, which may include detecting a message authentication code failure, a synchronization failure, or an authentication unacceptable error when attempting to authenticate the service request. The procedure related to the service request may include establishing the service over the established radio bearer. Further, the procedure may relate to establishing an emergency service, and the service request may be for the emergency service.

In another aspect, a user equipment (UE) for establishing services in wireless communications is provided. The UE may include a transceiver, at least one processor communicatively coupled with the transceiver via a bus for communicating signals in a wireless network, and a memory communicatively coupled with the at least one processor and/or the transceiver via the bus. The at least one processor and the memory may be operable to transmit, via the transceiver, a service request related to establishing a service over an established radio bearer, detect an authentication failure for the service request, determine whether a procedure related to the service request is successfully completed, and determine whether to terminate the established radio bearer based at least in part on the determination of whether the procedure related to the service request is successfully completed.

The at least one processor and the memory may be operable to determine whether to terminate the established radio bearer at least in part by determining whether to start a service request retransmission timer after expiration of which the established radio bearer is terminated. The at least one processor and the memory may be operable to determine whether to start the service request retransmission timer based on an expiration of an authentication failure timer initialized based on detecting the authentication failure. Further, the at least one processor and the memory may be operable to determine whether to start the service request retransmission timer at least in part by determining not to start the service request retransmission timer based on the expiration of the authentication failure timer where it is determined that the procedure related to the service request is successfully completed. Also, the at least one processor and the memory may be operable to determine whether to start the service request retransmission timer at least in part by determining to start the service request retransmission timer based on the expiration of the authentication failure timer where it is determined that the procedure related to the service request is not successfully completed. Furthermore, the at least one processor and the memory may be operable to determine whether the procedure related to the service request is successfully completed at least in part by determining whether the procedure related to the service request is successfully completed before the expiration of the authentication failure timer. Moreover, the service request retransmission timer may be a T3417 timer in 3GPP LTE related to retransmission of the service request.

The at least one processor and the memory may be operable to detect the authentication failure for the service request at least in part by detecting a message authentication code failure, a synchronization failure, or an authentication unacceptable error when attempting to authenticate the service request. Further, the procedure related to the service request may include establishing the service over the established radio bearer. The procedure may relate to establishing an emergency service, and the service request may be for the emergency service.

In yet another aspect, a UE for establishing services in wireless communications is provided. The UE may include means for transmitting a service request related to establishing a service over an established radio bearer, means for detecting an authentication failure for the service request, means for determining whether a procedure related to the service request is successfully completed, and means for determining whether to terminate the established radio bearer based at least in part on the determination of whether the procedure related to the service request is successfully completed.

The UE may also include the means for determining whether to terminate the established radio bearer determining whether to terminate the established radio bearer based at least in part on determining whether to start a service request retransmission timer after expiration of which the established radio bearer is terminated. The UE may further include the means for determining whether to start the service request retransmission timer determining whether to start the service request retransmission timer based on an expiration of an authentication failure timer initialized based on the means for detecting the authentication failure detecting the authentication failure. Also, the UE may include the means for determining whether to start the service request retransmission timer determining not to start the service request retransmission timer based on the expiration of the authentication failure timer where it is determined that the procedure related to the service request is successfully completed. The UE may additionally include the means for determining whether to start the service request retransmission timer determining to start the service request retransmission timer based on the expiration of the authentication failure timer where it is determined that the procedure related to the service request is not successfully completed.

In a further aspect, a computer-readable storage medium including computer-executable code for establishing services in wireless communications is provided. The code can include code for transmitting a service request related to establishing a service over an established radio bearer, code for detecting an authentication failure for the service request, code for determining whether a procedure related to the service request is successfully completed, and code for determining whether to terminate the established radio bearer based at least in part on the determination of whether the procedure related to the service request is successfully completed.

The computer-readable storage medium can also include the code for determining whether to terminate the established radio bearer determining whether to terminate the established radio bearer based at least in part on determining whether to start a service request retransmission timer after expiration of which the established radio bearer is terminated. The computer-readable storage medium may additionally include the code for determining whether to start the service request retransmission timer determining whether to start the service request retransmission timer based on an expiration of an authentication failure timer initialized based on the code for detecting the authentication failure detecting the authentication failure. Also, the computer-readable storage medium may include the code for determining whether to start the service request retransmission timer determining not to start the service request retransmission timer based on the expiration of the authentication failure timer where it is determined that the procedure related to the service request is successfully completed. The computer-readable storage medium may also include the code for determining whether to start the service request retransmission timer determining to start the service request retransmission timer based on the expiration of the authentication failure timer where it is determined that the procedure related to the service request is not successfully completed

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

In order to facilitate a fuller understanding of aspects described herein, reference is now made to the accompanying drawings, in which like elements are referenced with like numerals. These drawings should not be construed as limiting the present disclosure, but are intended to be illustrative only.

FIG. 1 shows a block diagram conceptually illustrating an example of a telecommunications system, in accordance with various aspects of the present disclosure.

FIG. 2 is a diagram illustrating an example of an access network in accordance with various aspects of the present disclosure.

FIG. 3 is a diagram illustrating an example of a downlink (DL) frame structure in accordance with various aspects of the present disclosure.

FIG. 4 is a diagram illustrating an example of an uplink (UL) frame structure in accordance with various aspects of the present disclosure.

FIG. 5 is a diagram illustrating an example of a radio protocol architecture for the user and control planes in accordance with various aspects of the present disclosure.

FIG. 6 is a diagram illustrating an example of an evolved Node B and user equipment in an access network in accordance with various aspects of the present disclosure.

FIG. 7 is a block diagram conceptually illustrating an example of a bearer architecture in a wireless communications system in accordance with various aspects of the present disclosure.

FIG. 8 is a diagram illustrating an example system for managing services based on authentication failure in accordance with various aspects of the present disclosure.

FIG. 9 is a flow chart of an example method for managing services based on authentication failure in accordance with various aspects of the present disclosure.

FIG. 10 is a diagram illustrating an example system for managing services and related timers based on authentication failure in accordance with various aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

Described herein are various aspects related to determining whether to terminate an established bearer with a network in the event of authentication failure for a service. For example, the service may relate to substantially any non-access stratum service or other network access that can be provided by a core network element via an evolved Node B (eNB). In one example, the service can be part of a non-access stratum service request (e.g., in LTE or other network technologies), which may include setting up a bearer and/or a packet data network (PDN) connection with the core network via the eNB. In one specific example, the non-access stratum service request can relate to setting up a bearer and/or PDN connection for emergency calling. In any case, the determination of whether to terminate the bearer may be based at least in part on determining whether a procedure related to the service (or service request) is completed. For example, the procedure may relate to establishing the service and/or a related bearer with the network. For example, where the procedure related to the service is successfully completed (e.g., where the service and/or related bearer is successfully established with the core network), the bearer may not be terminated though authentication may have failed, thus allowing the service to continue. In one example, where the service relates to emergency calling, and a bearer related to the emergency calling is successfully established between with the core network, even though authentication with the core network may fail, the service can remain established to facilitate conducting the emergency call. In one example, determining not to terminate the bearer can include determining not to initialize a timer associated with retransmitting/rejecting a service request for the service after expiration of a timer associated with the authentication failure.

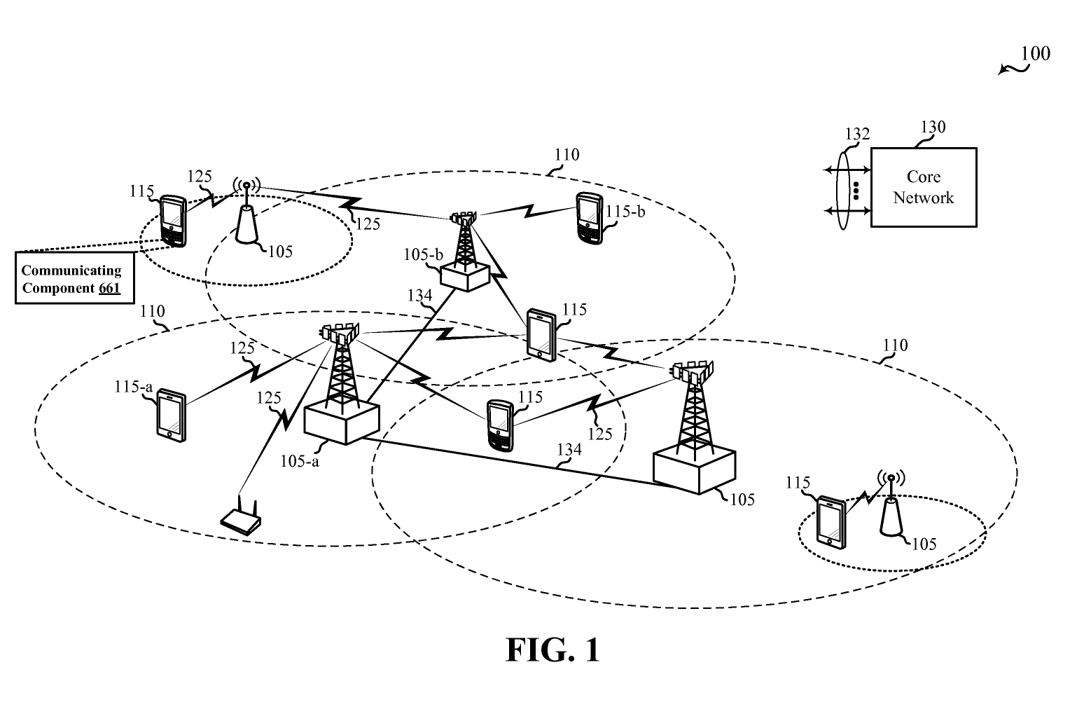

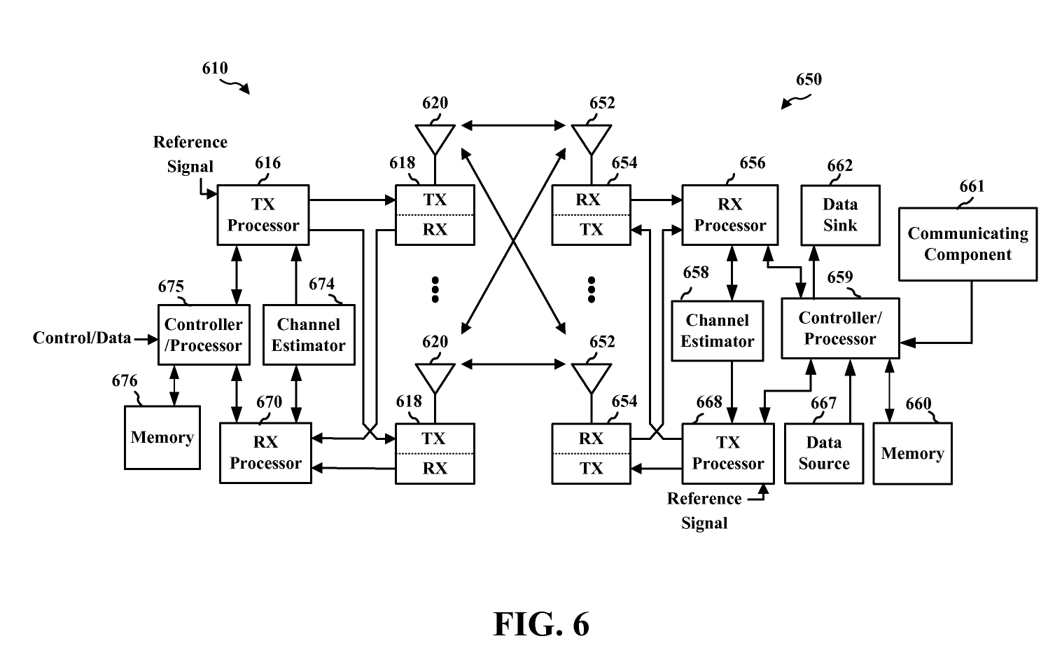

Referring first to FIG. 1, a diagram illustrates an example of a wireless communications system 100, in accordance with various aspects of the present disclosure. The wireless communications system 100 includes a plurality of access points (e.g., base stations, eNBs, or WLAN access points) 105, a number of user equipment (UEs) 115, and a core network 130. Access points 105 can, for example, transmit resource grants (e.g., for control and/or data uplink communications) to UEs 115 for communicating with the access points 105. UEs 115 can include a communicating component 661 for communicating with the access points 105 over the resource grants. In an example, communicating component 661 (see e.g., FIG. 6) can manage communications with the access points 105 such to establish and manage one or more services with one or more components of the core network 130. In addition, communicating component 661 can include one or more components for performing functions related to managing services and/or related timers based on an authentication failure in communicating with an access point 105, as described herein.

Some of the access points 105 may communicate with the UEs 115 under the control of a base station controller (not shown), which may be part of the core network 130 or the certain access points 105 (e.g., base stations or eNBs) in various examples. Access points 105 may communicate control information and/or user data with the core network 130 through backhaul links 132. In examples, the access points 105 may communicate, either directly or indirectly, with each other over backhaul links 134, which may be wired or wireless communication links. The wireless communications system 100 may support operation on multiple carriers (waveform signals of different frequencies). Multi-carrier transmitters can transmit modulated signals simultaneously on the multiple carriers. For example, each communication link 125 may be a multi-carrier signal modulated according to the various radio technologies described above. Each modulated signal may be sent on a different carrier and may carry control information (e.g., reference signals, control channels, etc.), overhead information, data, etc.

In this regard, a UE 115 can be configured to communicate with one or more access points 105 over multiple carriers using carrier aggregation (CA) (e.g., with one access point 105) and/or multiple connectivity (e.g., with multiple access points 105). In either case, UE 115 can be configured with at least one primary cell (PCell) configured to support uplink and downlink communications between UE 115 and an access point 105. It is to be appreciated that there can be a PCell for each communication link 125 between a UE 115 and a given access point 105. In addition, each of the communication links 125 can have one or more secondary cells (SCell) that can support uplink and/or downlink communications as well. In some examples, the PCell can be used to communicate at least a control channel, and the SCell can be used to communicate a data channel.

The access points 105 may wirelessly communicate with the UEs 115 via one or more access point antennas. Each of the access points 105 sites may provide communication coverage for a respective coverage area 110. In some examples, access points 105 may be referred to as a base transceiver station, a radio base station, a radio transceiver, a basic service set (BSS), an extended service set (ESS), a NodeB, eNB, Home NodeB, a Home eNB, or some other suitable terminology. The coverage area 110 for a base station may be divided into sectors making up only a portion of the coverage area (not shown). The wireless communications system 100 may include access points 105 of different types (e.g., macro, micro, and/or pico base stations). The access points 105 may also utilize different radio technologies, such as cellular and/or WLAN radio access technologies (RAT). The access points 105 may be associated with the same or different access networks or operator deployments. The coverage areas of different access points 105, including the coverage areas of the same or different types of access points 105, utilizing the same or different radio technologies, and/or belonging to the same or different access networks, may overlap.

In LTE/LTE-A network communication systems, the terms evolved Node B (eNodeB or eNB) may be used to describe the access points 105. The wireless communications system 100 may be a Heterogeneous LTE/LTE-A network in which different types of access points provide coverage for various geographical regions. For example, each access point 105 may provide communication coverage for a macro cell, a pico cell, a femto cell, and/or other types of cell. Small cells such as pico cells, femto cells, and/or other types of cells may include low power nodes or LPNs. A macro cell may cover a relatively large geographic area (e.g., several kilometers in radius) and may allow unrestricted access by UEs 115 with service subscriptions with the network provider. A small cell may cover a relatively smaller geographic area and may allow unrestricted access by UEs 115 with service subscriptions with the network provider, for example, and in addition to unrestricted access, may also provide restricted access by UEs 115 having an association with the small cell (e.g., UEs in a closed subscriber group (CSG), UEs for users in the home, and the like). An eNB for a macro cell may be referred to as a macro eNB. An eNB for a small cell may be referred to as a small cell eNB. An eNB may support one or multiple (e.g., two, three, four, and the like) cells.

The core network 130 may communicate with the eNBs or other access points 105 via one or more backhaul links 132 (e.g., S1 interface, etc.). The access points 105 may also communicate with one another, e.g., directly or indirectly via backhaul links 134 (e.g., X2 interface, etc.) and/or via backhaul links 132 (e.g., through core network 130). The wireless communications system 100 may support synchronous or asynchronous operation. For synchronous operation, the access points 105 may have similar frame timing, and transmissions from different access points 105 may be approximately aligned in time. For asynchronous operation, the access points 105 may have different frame timing, and transmissions from different access points 105 may not be aligned in time. The techniques described herein may be used for either synchronous or asynchronous operations.

The UEs 115 are dispersed throughout the wireless communications system 100, and each UE 115 may be stationary or mobile. A UE 115 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wearable item such as a watch or glasses, a wireless local loop (WLL) station, or the like. A UE 115 may be able to communicate with macro eNBs, small cell eNBs, relays, and the like. A UE 115 may also be able to communicate over different access networks, such as cellular or other WWAN access networks, or WLAN access networks.

The communication links 125 shown in wireless communications system 100 may include uplink (UL) transmissions from a UE 115 to an access point 105, and/or downlink (DL) transmissions, from an access point 105 to a UE 115. The downlink transmissions may also be called forward link transmissions while the uplink transmissions may also be called reverse link transmissions. The communication links 125 may carry transmissions of one or more hierarchical layers which, in some examples, may be multiplexed in the communication links 125. The UEs 115 may be configured to collaboratively communicate with multiple access points 105 through, for example, Multiple Input Multiple Output (MIMO), carrier aggregation (CA), Coordinated Multi-Point (CoMP), multiple connectivity (e.g., CA with each of one or more access points 105) or other schemes. MIMO techniques use multiple antennas on the access points 105 and/or multiple antennas on the UEs 115 to transmit multiple data streams. Carrier aggregation may utilize two or more component carriers on a same or different serving cell for data transmission. CoMP may include techniques for coordination of transmission and reception by a number of access points 105 to improve overall transmission quality for UEs 115 as well as increasing network and spectrum utilization.

As mentioned, in some examples access points 105 and UEs 115 may utilize carrier aggregation to transmit on multiple carriers. In some examples, access points 105 and UEs 115 may concurrently transmit in a first hierarchical layer, within a frame, one or more subframes each having a first subframe type using two or more separate carriers. Each carrier may have a bandwidth of, for example, 20 MHz, although other bandwidths may be utilized. For example, if four separate 20 MHz carriers are used in a carrier aggregation scheme in the first hierarchical layer, a single 80 MHz carrier may be used in the second hierarchical layer. The 80 MHz carrier may occupy a portion of the radio frequency spectrum that at least partially overlaps the radio frequency spectrum used by one or more of the four 20 MHz carriers. In some examples, scalable bandwidth for the second hierarchical layer type may be combined techniques to provide shorter RTTs such as described above, to provide further enhanced data rates.

Each of the different operating modes that may be employed by wireless communications system 100 may operate according to frequency division duplexing (FDD) or time division duplexing (TDD). In some examples, different hierarchical layers may operate according to different TDD or FDD modes. For example, a first hierarchical layer may operate according to FDD while a second hierarchical layer may operate according to TDD. In some examples, OFDMA communications signals may be used in the communication links 125 for LTE downlink transmissions for each hierarchical layer, while single carrier frequency division multiple access (SC-FDMA) communications signals may be used in the communication links 125 for LTE uplink transmissions in each hierarchical layer. Additional details regarding implementation of hierarchical layers in a system such as the wireless communications system 100, as well as other features and functions related to communications in such systems, are provided below with reference to the following figures.

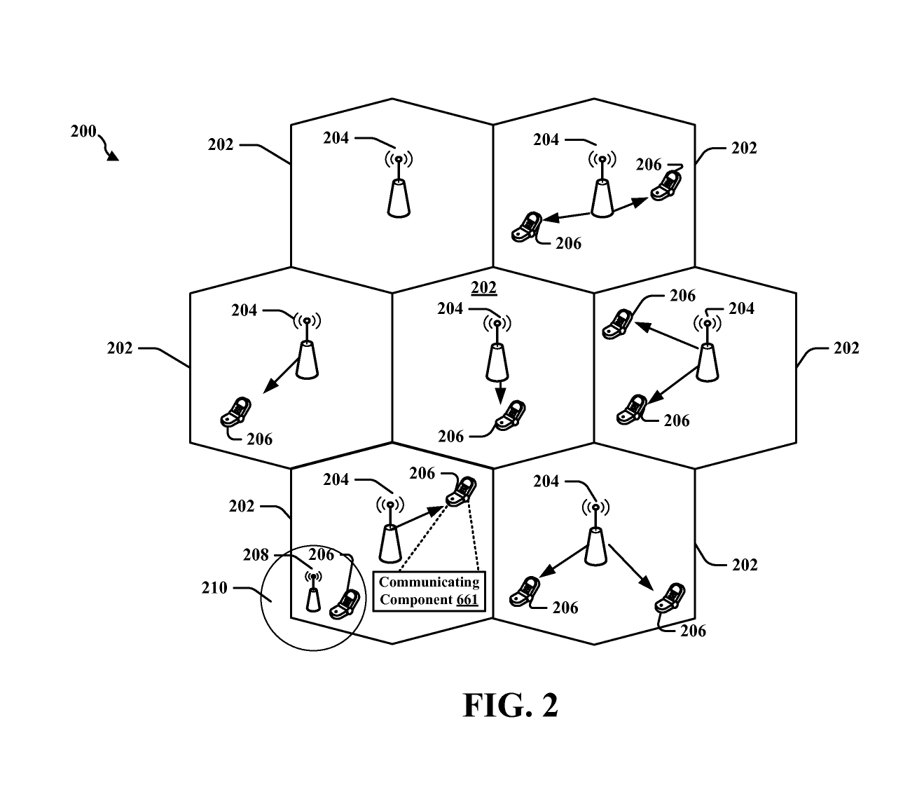

FIG. 2 is a diagram illustrating an example of an access network 200 in accordance with various aspects of the present disclosure. In this example, the access network 200 is divided into a number of cellular regions (cells) 202. One or more small cell eNBs 208 may have cellular regions 210 that overlap with one or more of the cells 202. The small cell eNBs 208 may be an eNB that provides a small cell (e.g., home eNB (HeNB)), femto cell pico cell, micro cell, or remote radio head (RRH). The macro eNBs 204 are each assigned to a respective cell 202 and are configured to provide an access point to a core network 130 for all the UEs 206 in the cells 202. UEs 206 may include a communicating component 661 for communicating with the eNBs 204 or 208, managing services and/or related timers based on an authentication failure in communicating with an eNB 204 or 208, etc. In an example, communicating component 661 can manage communications with the eNBs 204 or 208 such to establish and manage one or more services with one or more components of the core network 130. There is no centralized controller shown in this example of an access network 200, but a centralized controller may be used in alternative configurations. The eNBs 204 are responsible for all radio related functions including radio bearer control, admission control, mobility control, scheduling, security, and connectivity to a serving gateway.

The modulation and multiple access scheme employed by the access network 200 may vary depending on the particular telecommunications standard being deployed. In LTE applications, OFDM may be used on the DL and SC-FDMA may be used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing may be used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

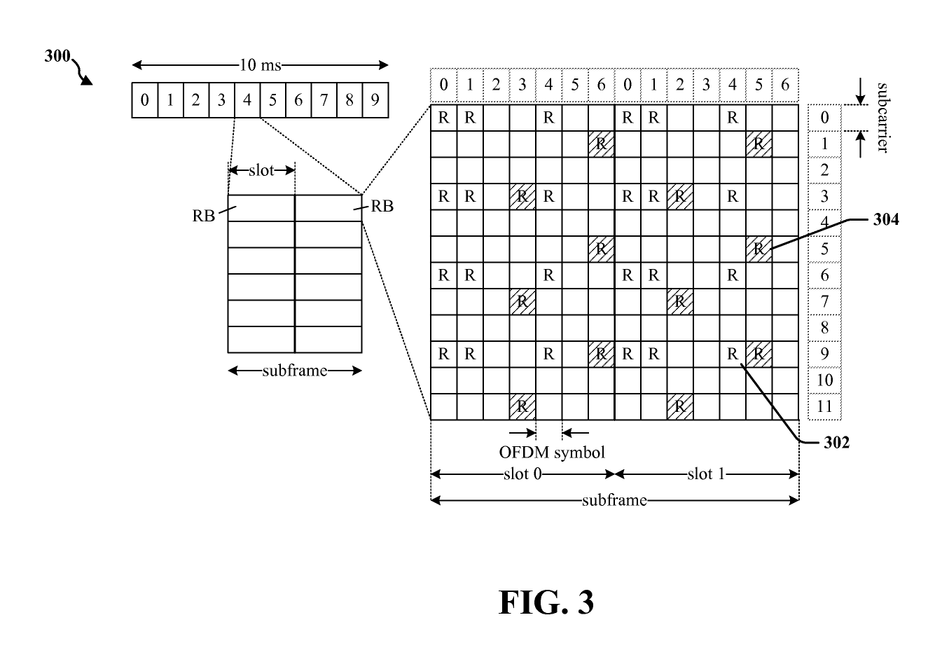

FIG. 3 is a diagram 300 illustrating an example of a DL frame structure in accordance with various aspects of the present disclosure. A frame (10 ms) may be divided into 10 equally sized sub-frames. Each sub-frame may include two consecutive time slots. A resource grid may be used to represent two time slots, each time slot including a resource element block. The resource grid is divided into multiple resource elements. A resource element block may contain 12 consecutive subcarriers in the frequency domain and, for a normal cyclic prefix in each OFDM symbol, 7 consecutive OFDM symbols in the time domain, or 84 resource elements. For an extended cyclic prefix, a resource element block may contain 6 consecutive OFDM symbols in the time domain and has 72 resource elements. Some of the resource elements, as indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource element blocks upon which the corresponding physical downlink shared channel (PDSCH) is mapped. The number of bits carried by each resource element depends on the modulation scheme. Thus, the more resource element blocks that a UE receives and the higher the modulation scheme, the higher the data rate for the UE.

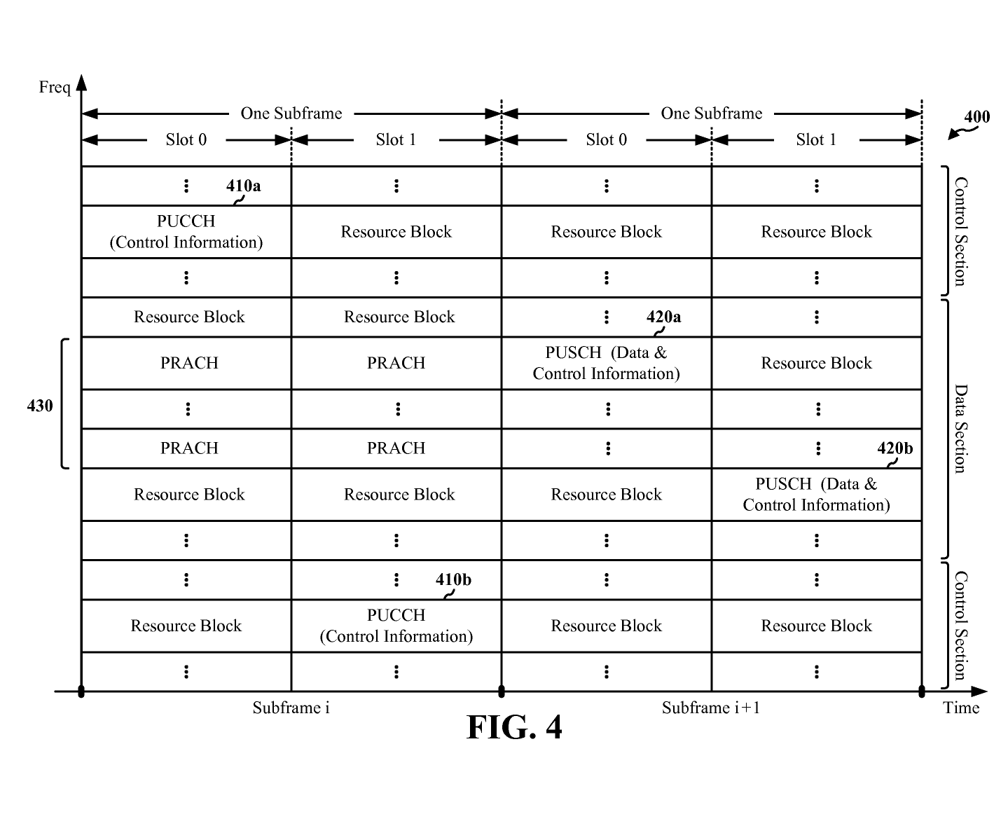

FIG. 4 is a diagram 400 illustrating an example of an UL frame structure in accordance with various aspects of the present disclosure. The available resource element blocks for the UL may be partitioned into a data section and a control section. The control section may be formed at the two edges of the system bandwidth and may have a configurable size. The resource element blocks in the control section may be assigned to UEs for transmission of control information. The data section may include all resource element blocks not included in the control section. The UL frame structure results in the data section including contiguous subcarriers, which may allow a single UE to be assigned all of the contiguous subcarriers in the data section.

A UE may be assigned resource element blocks 410a, 410b in the control section to transmit control information to an eNB. The UE may also be assigned resource element blocks 420a, 420b in the data section to transmit data to the eNB. The UE may transmit control information in a physical UL control channel (PUCCH) on the assigned resource element blocks in the control section. The UE may transmit only data or both data and control information in a physical UL shared channel (PUSCH) on the assigned resource element blocks in the data section. A UL transmission may span both slots of a subframe and may hop across frequency.

A set of resource element blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource element blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

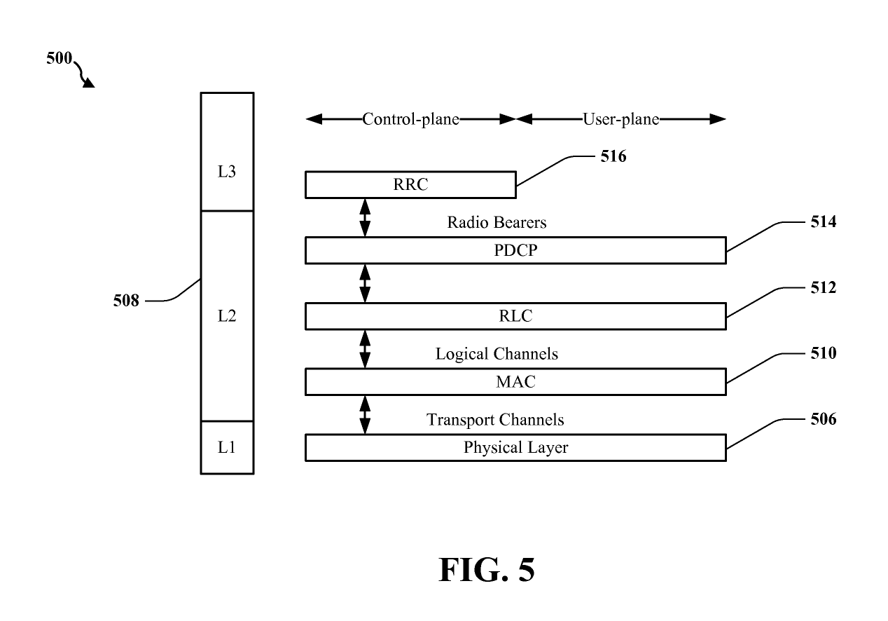

FIG. 5 is a diagram 500 illustrating an example of a radio protocol architecture for the user and control planes in accordance with various aspects of the present disclosure. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at a PDN gateway on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource element blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

FIG. 6 is a block diagram of an eNB 610 in communication with a UE 650 in an access network in accordance with various aspects of the present disclosure. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations. In addition, UE 650 may include a communicating component 661 for communicating with the eNB 610. In an example, communicating component 661 can manage communications with the eNB 610 such to establish and manage one or more services with one or more components of a core network. Though shown as coupled to controller/processor 659, it is to be appreciated that the communicating component 661 and/or related components or functions, can each be executed by, implemented by, etc., substantially any processor of UE 650, including TX processor 668, RX processor 656, controller/processor 659, etc., and/or memory 660 can store instructions and/or related parameters for performing the functions.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the controller/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

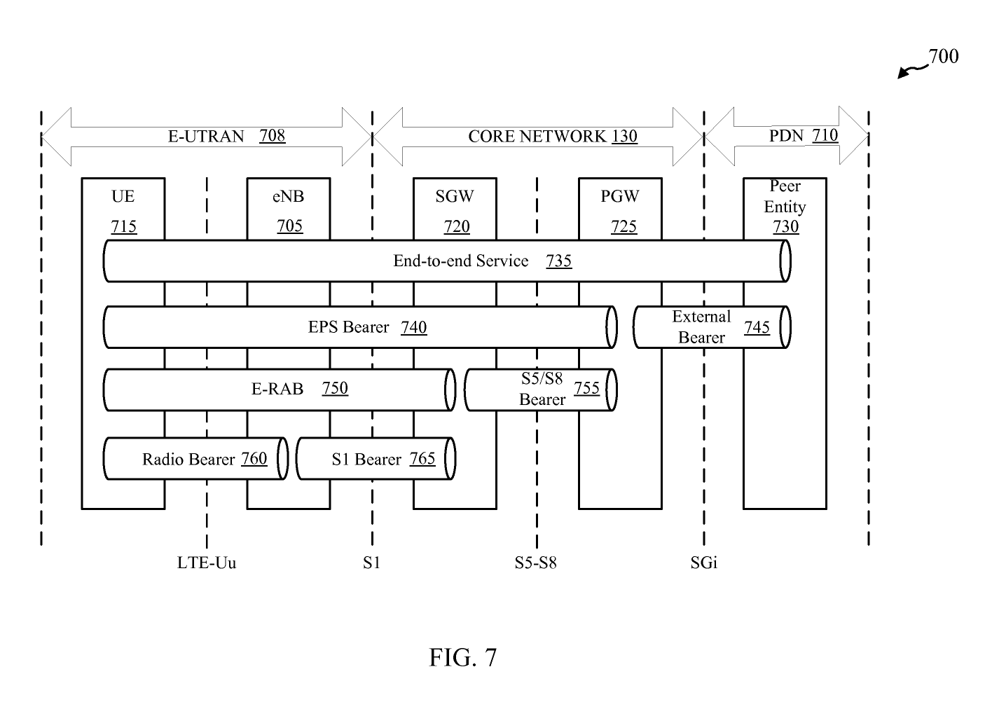

FIG. 7 is a block diagram conceptually illustrating an example of a bearer architecture in a wireless communications system 700, in accordance with various aspects of the present disclosure. The bearer architecture may be used to provide an end-to-end service 735 between a UE 715 and a peer entity 730 addressable over a network. The peer entity 730 may be a server, another UE, or another type of network-addressable device. The end-to-end service 735 may forward data between UE 715 and the peer entity 730 according to a set of characteristics (e.g., a quality of service (QoS)) associated with the end-to-end service 735. The end-to-end service 735 may be implemented by at least the UE 715, an eNB 705, a serving gateway (SGW) 720, a packet data network (PDN) gateway (PGW) 725, and the peer entity 730. The UE 715 and eNB 705 may be components of an evolved UMTS terrestrial radio access network (E-UTRAN) 708, which is the air interface of the LTE/LTE-A systems. The serving gateway (SGW) 720 and PDN gateway (PGW) 725 may be components of a core network 130 (e.g., components of an EPC in a LTE/LTE-A system). The peer entity 730 may be an addressable node on a PDN 710 communicatively coupled with the PGW 725.

The end-to-end service 735 may be implemented by an evolved packet system (EPS) bearer 740 between the UE 715 and the PGW 725, and by an external bearer 745 between the PGW 725 and the peer entity 730 over an SGi interface. The SGi interface may expose an internet protocol (IP) or other network-layer address of the UE 715 to the PDN 710.

The EPS bearer 740 may be an end-to-end tunnel, which may be defined to achieve a specific QoS. Each EPS bearer 740 may be associated with a plurality of parameters, for example, a QoS class identifier (QCI), an allocation and retention priority (ARP), a guaranteed bit rate (GBR), an aggregate maximum bit rate (AMBR), etc. The QCI may be an integer indicative of a QoS class associated with a predefined packet forwarding treatment in terms of latency, packet loss, GBR, priority, and/or the like. In certain examples, the QCI may be an integer from 1 to 9. The ARP may be used by a scheduler of an eNB 705 to provide preemption priority in the case of contention between two different bearers for the same resources. The GBR may specify separate downlink and uplink guaranteed bit rates. Certain QoS classes may be non-GBR such that no guaranteed bit rate is defined for bearers of those classes.

The EPS bearer 740 may be implemented by an E-UTRAN radio access bearer (E-RAB) 750 between the UE 715 and the SGW 720, and an S5/S8 bearer 755 between the SGW 720 and the PDN gateway over an S5 or S8 interface. S5 refers to the signaling interface between the SGW 720 and the PGW 725 in a non-roaming scenario, and S8 refers to an analogous signaling interface between the SGW 720 and the PGW 725 in a roaming scenario. The E-RAB 750 may be implemented by a radio bearer 760 between the UE 715 and the eNB 705 over an LTE-Uu air interface and by an S1 bearer 765 between the eNB 705 and the SGW 720 over an S1 interface.

It will be understood that, while FIG. 7 illustrates an example bearer hierarchy in the context of an example of end-to-end service 735 between the UE 715 and the peer entity 730, certain bearers may be used to convey data unrelated to end-to-end service 735. For example, radio bearers 760 or other types of bearers may be established to transmit control data between two or more entities where the control data is unrelated to the data of the end-to-end service 735.

As discussed above with respect to FIG. 1, UE 715 may establish an EPS bearer 740 with PGW 725 or other core network components to facilitate establishing one or more services with core network 130. UE 715 can manage the EPS bearer 740 based on whether the service is established even when authentication failure for the service occurs.

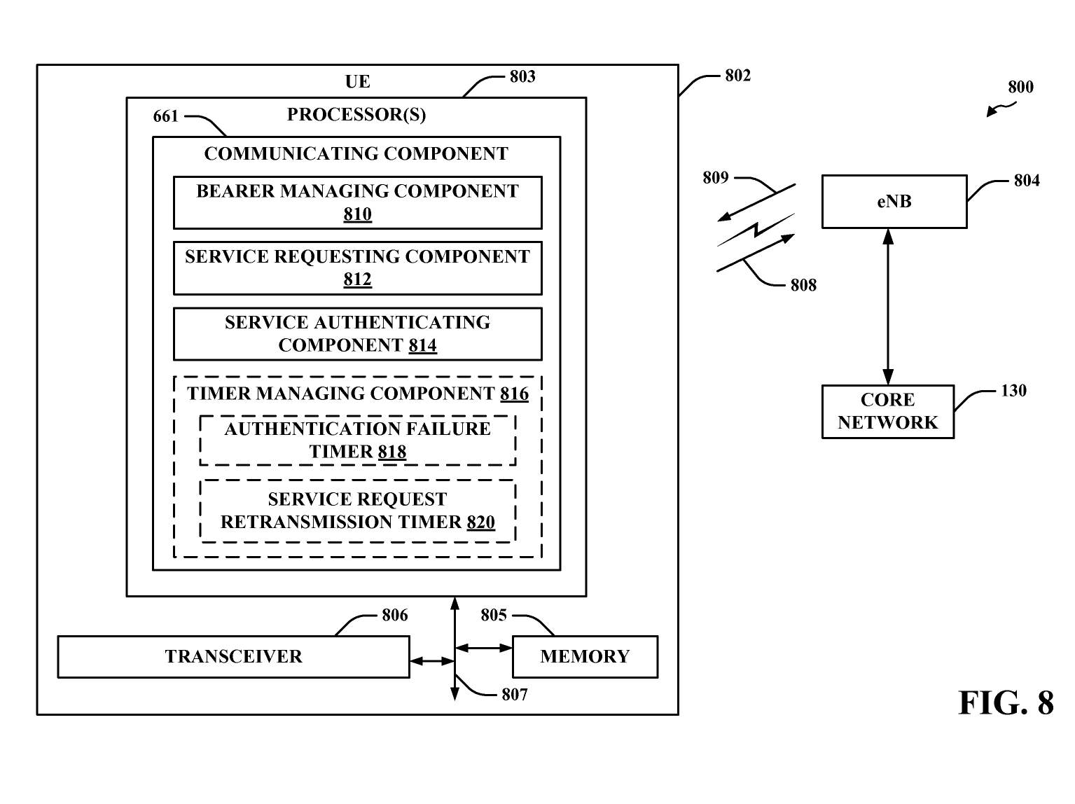

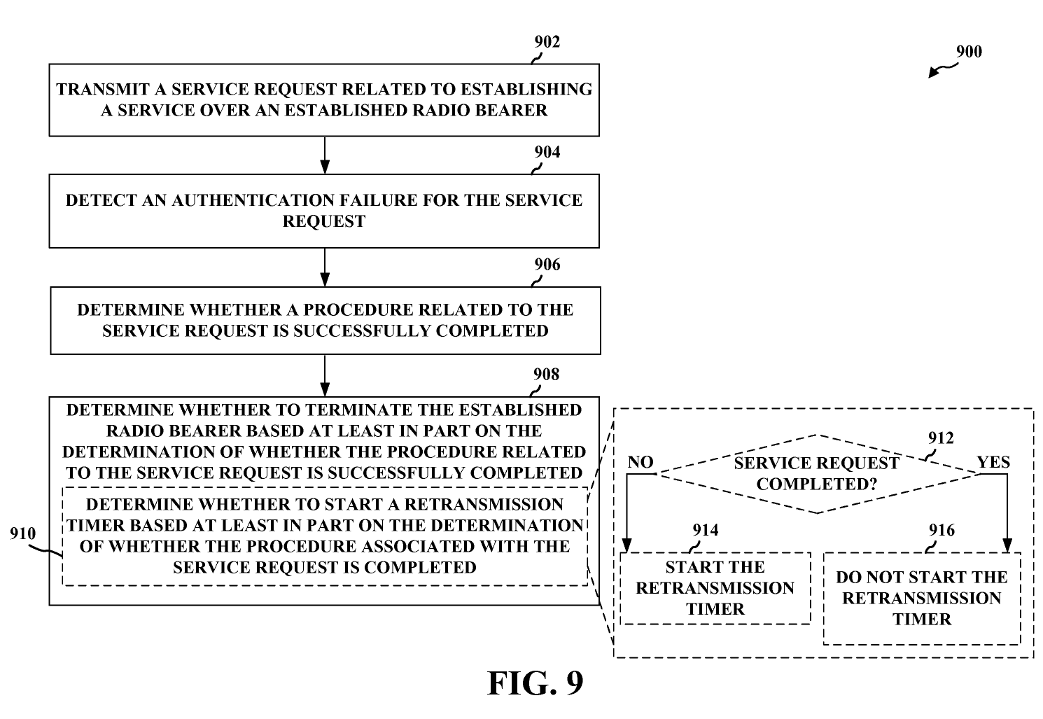

Referring to FIGS. 8 and 9, aspects are depicted with reference to one or more components and one or more methods that may perform the actions or functions described herein. In an aspect, the term “component” as used herein may be one of the parts that make up a system, may be hardware or software or some combination thereof, and may be divided into other components. Although the operations described below in FIG. 9 are presented in a particular order and/or as being performed by an example component, it should be understood that the ordering of the actions and the components performing the actions may be varied, depending on the implementation. Moreover, it should be understood that the following actions or functions may be performed by a specially-programmed processor, a processor executing specially-programmed software or computer-readable media, or by any other combination of a hardware component and/or a software component capable of performing the described actions or functions.

FIG. 8 illustrates an example system 800 for managing services when authentication failure occurs in wireless communications in accordance with various aspects of the present disclosure. System 800 includes a UE 802 that communicates with an eNB 804 to access a core network 130, examples of which are described in FIGS. 1, 2, 6, and 7 (e.g., access points 105, eNB 204, 208, eNB 610, eNB 705, UEs 115, 206, 650, 715, etc.), above. In an aspect, eNB 804 and UE 802 may have established one or more downlink channels over which to communicate via downlink signals 809, which can be transmitted by eNB 804 and received by UE 802 (e.g., via transceiver 806) for communicating control and/or data messages (e.g., in signaling) from the eNB 804 to the UE 802 over configured communication resources. Moreover, for example, eNB 804 and UE 802 may have established one or more uplink channels over which to communicate via uplink signals 808, which can be transmitted by UE 802 (e.g., via transceiver 806) and received by eNB 804 for communicating control and/or data messages (e.g., in signaling) from the UE 802 to the eNB 804 over configured communication resources. eNB 804 may also include a transceiver (not shown) to facilitate communicating with UE 802.

In an aspect, UE 802 may include one or more processors 803 and/or a memory 805 that may be communicatively coupled, e.g., via one or more buses 807, and may operate in conjunction with or otherwise implement a communicating component 661 for managing communications with the core network 130 (e.g., via eNB 804) to establish one or more services with the core network 130. For example, the various operations related to communicating component 661 may be implemented or otherwise executed by one or more processors 803 and, in an aspect, can be executed by a single processor, while in other aspects, different ones of the operations may be executed by a combination of two or more different processors. For example, in an aspect, the one or more processors 803 may include any one or any combination of a modem processor, or a baseband processor, or a digital signal processor, or an application specific integrated circuit (ASIC), or a transmit processor, receive processor, or a transceiver processor associated with transceiver 806. Further, for example, the memory 805 may be a non-transitory computer-readable medium that includes, but is not limited to, random access memory (RAM), read only memory (ROM), programmable ROM (PROM), erasable PROM (EPROM), electrically erasable PROM (EEPROM), a magnetic storage device (e.g., hard disk, floppy disk, magnetic strip), an optical disk (e.g., compact disk (CD), digital versatile disk (DVD)), a smart card, a flash memory device (e.g., card, stick, key drive), a register, a removable disk, and any other suitable medium for storing software and/or computer-readable code or instructions that may be accessed and read by a computer or one or more processors 803. Moreover, memory 805 or computer-readable storage medium may be resident in the one or more processors 803, external to the one or more processors 803, distributed across multiple entities including the one or more processors 803, etc.

In particular, the one or more processors 803 and/or memory 805 may execute actions or operations defined by communicating component 661 or its subcomponents. For instance, the one or more processors 803 and/or memory 805 may execute actions or operations defined by a bearer managing component 810 for establishing, managing, and/or terminating one or more bearers with a core network (e.g., an EPS bearer with core network 130) and/or with an access point (e.g., eNB 804), etc. In an aspect, for example, bearer managing component 810 may include hardware (e.g., one or more processor modules of the one or more processors 803) and/or computer-readable code or instructions stored in memory 805 and executable by at least one of the one or more processors 803 to perform the specially configured bearer managing operations described herein. Further, for instance, the one or more processors 803 and/or memory 805 may execute actions or operations defined by a service requesting component 812 for requesting establishment of one or more services with the core network. In an aspect, for example, service requesting component 812 may include hardware (e.g., one or more processor modules of the one or more processors 803) and/or computer-readable code or instructions stored in memory 805 and executable by at least one of the one or more processors 803 to perform the specially configured service requesting operations described herein. Further, for instance, the one or more processors 803 and/or memory 805 may execute actions or operations defined by a service authenticating component 814 for processing an authentication request relating to one or more services. In an aspect, for example, service authenticating component 814 may include hardware (e.g., one or more processor modules of the one or more processors 803) and/or computer-readable code or instructions stored in memory 805 and executable by at least one of the one or more processors 803 to perform the specially configured service authenticating operations described herein.

Moreover, for instance, the one or more processors 803 and/or memory 805 may optionally execute actions or operations defined by a timer managing component 816 for managing one or more timers associated with a service, such as an authentication failure timer 818 relating to a period of time during which authentication can be attempted, and/or a service request retransmission timer 820 relating to a period of time during which the service related to the service request can be established with the core network 130 based on retransmitting the service request. In an aspect, for example, timer managing component 816 may include hardware (e.g., one or more processor modules of the one or more processors 803) and/or computer-readable code or instructions stored in memory 805 and executable by at least one of the one or more processors 803 to perform the specially configured timer managing operations described herein.

It is to be appreciated that transceiver 806 may be configured to transmit and receive wireless signals through one or more antennas, an RF front end, one or more transmitters, and one or more receivers. In an aspect, transceiver 806 may be tuned to operate at specified frequencies such that UE 802 can communicate at a certain frequency. In an aspect, the one or more processors 803 may configure transceiver 806 to operate at a specified frequency and power level based on a configuration, a communication protocol, etc. to communicate uplink signals 808 and/or downlink signals 809, respectively, over related uplink or downlink communication channels with eNB 804.

In an aspect, transceiver 806 can operate in multiple bands (e.g., using a multiband-multimode modem, not shown) such to process digital data sent and received using transceiver 806. In an aspect, transceiver 806 can be multiband and be configured to support multiple frequency bands for a specific communications protocol. In an aspect, transceiver 806 can be configured to support multiple operating networks and communications protocols. Thus, for example, transceiver 806 may enable transmission and/or reception of signals based on a specified modem configuration.

In one example, bearer managing component 810 can establish a bearer with the core network 130, which can include establishing an EPS bearer 740 as described in FIG. 7. This can include UE 802 initially accessing the core network 130 via a E-UTRAN 708, the UE 802 moving from an idle mode to an active mode in the E-UTRAN 708, etc. When the EPS bearer 740 is established, the UE 802 can request one or more services with core network 130 via eNB 804.

FIG. 9 illustrates an example method 900 for managing a service requested with a core network when authentication failure occurs in accordance with various aspects of the present disclosure. The operation of method 900 of FIG. 9 will now be discussed, in one non-limiting context, with reference to the architecture of system 800 of FIG. 8 and with reference to UE 802 and its components. Method 900 includes, at Block 902, transmitting a service request (e.g., a non-access stratum request) related to establishing a service over an established radio bearer. In an aspect, service requesting component 812, e.g., operating in conjunction with one or more processors 803, memory 805, and/or transceiver 806, can transmit the service request (e.g., as part of a non-access stratum service request procedure in LTE) related to establishing the service (e.g., the non-access stratum service) over the established radio bearer, which can be the bearer established with core network 130 by bearer managing component 810 (e.g., the EPS bearer 740). For example, service requesting component 812 can generate the service request, and transmit the service request via communicating component 661 (e.g., using an associated transmitter, transmit processor, etc., as described herein) to eNB 804 for providing to the core network 130. For instance, the service request can relate to a request for establishing a service that may not require successful service authentication. In one specific example, such services may include an emergency service (e.g., emergency voice and/or data call services) where the UE 802 can establish a connection with the core network 130 to conduct an emergency call and/or other emergency data transfer. In addition, service requesting component 812 may transmit the request to one or more components of core network 130 via eNB 804, such as a mobility management entity (MME) via one or more gateways (e.g., SGW/PGW), etc.

Method 900 also includes, at Block 904, detecting an authentication failure for the service request. In an aspect, service authenticating component 814, e.g., operating in conjunction with one or more processors 803 and memory 805, can detect the authentication failure for the service request. For example, service authenticating component 814 can receive an authentication request from one or more components of core network 130 (e.g. based on the service request related to the service) and can attempt to authenticate the service based at least in part on the authentication request. Service authenticating component 814, in this example, may detect authentication failure, however, for one or more reasons. For example, service authenticating component 814 may detect authentication failure by detecting an error in message authentication code, an error in synchronization with the one or more access points or core network 130 (e.g., an invalid sequence number received from the core network 130), and/or the like. In specific examples, service authenticating component 814 may detect one or more cause codes in LTE, such as cause codes references in 3GPP technical specification (TS) 24.301, section 5.4.2.7 including an “EPS mobility management (EMM) cause 20” error related to message authentication code failure, an “EMM cause 21” error related to a synchronization failure (e.g., due to incorrect sequence numbering of received EPS packets), an “EMM cause 26” error related to a non-EPS authentication unacceptable, etc. in the authentication request received from the core network 130.

It is to be appreciated, however, the UE 802 may not consider that the core network 130 has failed the authentication check based on this authentication failure for services that do not require authentication, such as establishing the emergency PDN connection for emergency services, and thus the UE 802 may not request release of the EPS bearer 704 (or other RRC connections or related radio resources) and may not treat the eNB 804 or a cell provided thereby as a barred cell. In addition, in this regard and as explained further herein, where the UE 802 detects the authentication failure, the UE 802 (e.g., via timer managing component 816) may refrain from starting one or more retransmission timers (e.g., T3410, T3417, T3421, or T3430) if they were running and stopped when the UE 802 detected authentication failure (e.g., based on receiving the authentication request with the invalid message authentication code and/or sequence number). Instead, for example, the UE 802 can continue using a current security context, if any, when communicating with core network 130 and/or eNB 804, and may deactivate non-emergency EPS bearer contexts, if any, by initiating a UE requested PDN disconnect procedure. If there is an ongoing PDN connectivity procedure at the UE 802, the UE 802 may deactivate non-emergency EPS bearer contexts upon completion of the PDN connectivity procedure. The UE 802 may or may not start retransmission timers (e.g. T3410, T3417, T3421 or T3430), if they were running and stopped when the UE 802 detected an authentication failure, as described further herein. In addition, the UE 802 may consider itself to be attached to the core network 130 for emergency bearer services only, in this example.

Method 900 further includes, at Block 906, determining whether a procedure related to the service request is successfully completed. Service requesting component 812, e.g., operating in conjunction with one or more processors 803 and memory 805, can determine whether the procedure related to the service request is successfully completed. For instance, the service request can be a non-access stratum request to the core network 130 related to establishing an emergency voice call or data call service, as described, which relates to performing a service request procedure with the core network 130. For example, the procedure related to the service request (or service request procedure) may include, but it not limited to, a non-access stratum procedure with core network 130 to establish emergency PDN connectivity (e.g., without requiring authentication of the UE 802). If the service request procedure succeeds, service requesting component 812 can facilitate communicating with core network 130 to provide the service related to the service request. As described, the procedure may succeed where the service does not necessarily require successful service authentication (e.g., in emergency calling services). Moreover, in an example, service requesting component 812 can determine whether the procedure succeeded during a period of time (e.g., before expiration of an authentication failure timer 818, such as timer T3420 in LTE, after detecting failure of an authentication procedure).

Method 900 also includes, at Block 908, determining whether to terminate the established radio bearer based at least in part on the determination of whether the procedure related to the service request is successfully completed. In an aspect, bearer managing component 810, e.g., operating in conjunction with one or more processors 803 and memory 805, may determine whether to terminate the established radio bearer based at least in part on the determination by the service requesting component 812 of whether the procedure related to the service request is successfully completed. Thus, as described, where service requesting component 812 determines that the procedure related to the service request is successfully completed, bearer managing component 810 may determine to not terminate the bearer such to allow the related service to continue. Where service requesting component 812 determines that the procedure related to the service request is not successfully completed, however, bearer managing component 810 may determine to terminate the bearer.

In an example, bearer managing component 810 may determine whether to terminate the established radio bearer by using timer managing component 816 to manage one or more timers. For example, determining whether to terminate the established radio bearer at Block 908 may optionally include, at Block 910, determining whether to start a retransmission timer based at least in part on the determination of whether the procedure associated with the service request is completed. In an aspect, bearer managing component 810 can determine whether to start a retransmission timer (e.g., service request retransmission timer 820) via timer managing component 816 based at least in part on the determination of whether the procedure associated with the service request is completed. As described, this may include service requesting component 812 determining whether the procedure succeeded during a period of time (e.g., before expiration of an authentication failure timer 818, such as timer T3420 in LTE, after detecting failure of an authentication procedure). In one example, determining whether to start the retransmission timer at Block 910 may optionally include, at Block 912, determining whether the service request completed. In an aspect, bearer managing component 810 can determine whether the service request completed (e.g., during a period of time defined by the authentication failure timer 818). If not, Block 910 may optionally include, at Block 914, starting the retransmission timer, and if so, Block 910 may optionally include, at Block 916, not starting the retransmission timer. In an aspect, bearer managing component 810 can employ timer managing component 816 for accordingly starting or not starting the retransmission timer.

For example, where bearer managing component 810 determines to terminate the established radio bearer (e.g., where the procedure associated with the service request is not completed before expiration of the authentication failure timer 818), timer managing component 816 may initialize, continue, or restart the service request retransmission timer 820, which can relate to retransmitting/rejecting the service request based on determining that the related service request (or service procedure related to the service request) failed to complete. Thus, service requesting component 812 may retransmit requests to establish the service with core network 130 while the service request retransmission timer 820 is running, but when the service request retransmission timer 820 expires, bearer managing component 810 may terminate the bearer established with eNB 804 and/or core network 130. Where bearer managing component 810 determines not to terminate the established radio bearer in this example, however (e.g., where the procedure associated with the service request to establish the associated EPS bearer and/or PDN connection is successfully completed before expiration of the authentication failure timer 818), timer managing component 816 may refrain from initializing, continuing, or restarting the service request retransmission timer 820, which can relate to not retransmitting/rejecting the service request based on determining that the related service request (or service procedure related to the service request) has completed (though authentication may have failed).

In an example, service request retransmission timer 820, when determined to be initialized, continued, or restarted, may not start until after expiration of an authentication failure timer 818, which can be initialized when service authenticating component 814 detects the authentication failure. In this regard, for example, bearer managing component 810 may determine to initialize the service request retransmission timer 820 before expiration of the authentication failure timer 818, but timer managing component 816 may not start the service request retransmission timer 820 until expiration of the authentication failure timer 818 (e.g., where the authentication failure timer 818 expires without service authenticating component 814 performing a successful service authentication). Delaying the service request retransmission timer 820 until after expiration of the authentication failure timer 818, in this regard, can allow subsequent authentication requests for the service before the service request retransmission timer 820 starts. It is to be appreciated that service requesting component 812 may similarly transmit additional service requests before the service request retransmission timer 820 expires.

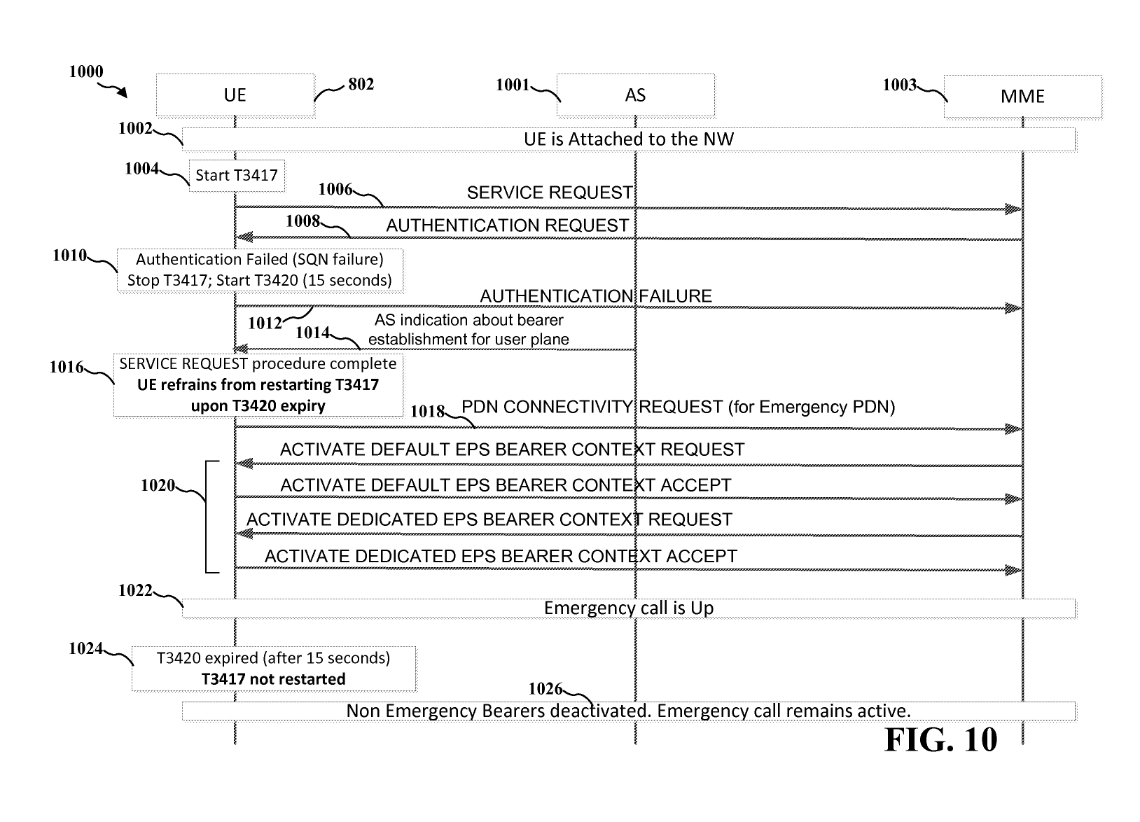

In a specific example, described further with respect to FIG. 10, the authentication failure timer 818 may include a T3420 or T3418 timer, and the service request retransmission timer 820 may include a T3417 timer in 3GPP LTE. In this specific example, service requesting component 812 can transmit a service request to core network 130, and service authenticating component 814 can determine that an authentication request for the service fails at UE 802. Accordingly, timer managing component 816 can initialize the authentication failure timer 818, which can be a T3420 or T3418 timer, and may suspend the service request retransmission timer 820 if it is running, which may be a T3417 timer. Service authenticating component 814 may indicate the authentication failure to the core network 130, which may ignore the authentication failure (e.g., based on the service type, which may relate to emergency services), and core network 130 can complete a procedure associated with the service request (e.g., to establish emergency services between the UE 802 and core network 130). In this regard, bearer managing component 810 can determine not to terminate the established bearer, which can include causing timer managing component 816 to not resume the service request retransmission timer 820 (the T3417 timer) based on (e.g., following) expiration of the authentication failure timer 818 (the T3420 or T3418 timer). This allows UE 802 to continue the requested service with core network 130 where authentication is not required. It is to be appreciated, in this regard, that the service may relate to emergency services, a lower level of service for which authentication is not required, and/or substantially any service that does not require successful authentication. If one or more procedures associated with the service request are not successfully completed, however, timer managing component 816 may resume service request retransmission timer 820 (the T3417 timer) to allow the UE 802 to continue to attempt the procedures based on the service request (e.g., to establish a PDN connection for emergency services).

FIG. 10 illustrates an example system 1000 for establishing services in accordance with various aspects of the present disclosure. System 1000 includes a UE 802, an access stratum (AS) (e.g., provided by an eNB 804), and an MME 1003 (e.g., of a core network 130). The following operations discussed in FIG. 10 with respect to UE 802 may be performed by one or more components of UE 802 as described above and as described herein. At 1002, UE 802 is attached to a network using AS 1001 (e.g., E-UTRAN), that may include one or more access points (e.g., eNB 804), to communicate with one or more core network components, such as an MME 1003. At 1004, the UE 802 can start a T3417 timer related to requesting a service with the core network (e.g., with MME 1003). UE 802 can accordingly transmit a service request 1006 to the MME 1003, which may include transmitting the service request 1006 over a bearer with the MME 1003, as described above, and transmitting the service request 1006 can be similar to service requesting component 812 transmitting the service request to core network 130 in FIG. 8, and/or transmitting the service request at Block 902 in FIG. 9. The service request may relate to bringing up an emergency PDN connection.

The MME 1003 can transmit an authentication request 1008 to UE 802, and UE 802 can detect an authentication failure at 1010, which may be due to message authentication code failure, synchronization failure (due to unexpected sequence numbers (SQN)), etc. For example, UE 802 detecting the authentication failure at 1010 can be similar to service authenticating component 814 detecting authentication failure in FIG. 8, and/or detecting authentication failure in Block 904 of FIG. 9. UE 802 can indicate the authentication failure to MME 1003 at 1012, but can receive an AS indication regarding bearer establishment for the user plane at 1014. Thus, the service procedure can be completed, though authentication failed. Accordingly, the UE 802 detects the service request procedure successfully completed, at 1016, and the UE 802 can refrain from restarting the T3417 timer upon expiration of the T3420 timer. This can be similar to bearer managing component 810 determining to not terminate the bearer and accordingly causing timer managing component 816 to not start the service request retransmission timer 820 after expiration of the authentication failure timer 818 based on service requesting component 812 determining successful completion of the procedure, as described in FIG. 8, and/or determining not to terminate the established bearer in Block 908 based on determining successful completion of the procedure in Block 906 of FIG. 9.

The UE 802 can send a PDN connectivity request to the MME 1003 at 1018, and the UE 802 and MME 1003 can activate associated EPS bearers based on one or more request/accept messages shown at 1020. At 1022, the emergency call is up between the UE 802 and MME 1003. The T3420 can expire at 1024, and as described, the UE 802 determines not to restart the T3417 timer (at least for the bearer related to the emergency PDN connection. Based on possible expiration of T3417 for other non-emergency bearers (e.g., where authentication may be required), non-emergency bearers may be deactivated at 1026.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described herein that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for establishing services in wireless communications, comprising:
transmitting a service request related to establishing a service over an established radio bearer;
detecting an authentication failure for the service request;
determining whether a procedure related to the service request is successfully completed; and
determining whether to terminate the established radio bearer based at least in part on the determination of whether the procedure related to the service request is successfully completed.

2. The method of claim 1, wherein determining whether to terminate the established radio bearer comprises determining whether to start a service request retransmission timer after expiration of which the established radio bearer is terminated.

3. The method of claim 2, wherein determining whether to start the service request retransmission timer occurs based on an expiration of an authentication failure timer initialized based on detecting the authentication failure.

4. The method of claim 3, wherein determining whether to start the service request retransmission timer comprises determining not to start the service request retransmission timer based on the expiration of the authentication failure timer where it is determined that the procedure related to the service request is successfully completed.

5. The method of claim 3, wherein determining whether to start the service request retransmission timer comprises determining to start the service request retransmission timer based on the expiration of the authentication failure timer where it is determined that the procedure related to the service request is not successfully completed.

6. The method of claim 3, wherein determining whether the procedure related to the service request is successfully completed comprises determining whether the procedure related to the service request is successfully completed before the expiration of the authentication failure timer.

7. The method of claim 3, wherein the service request retransmission timer is a T3417 timer in third generation partnership project (3GPP) long term evolution (LTE) related to retransmission of the service request.

8. The method of claim 1, wherein detecting the authentication failure for the service request comprises detecting a message authentication code failure, a synchronization failure, or an authentication unacceptable error when attempting to authenticate the service request.

9. The method of claim 1, wherein the procedure related to the service request comprises establishing the service over the established radio bearer.

10. The method of claim 1, wherein the procedure relates to establishing an emergency service, and wherein the service request is for the emergency service.

11. A user equipment for establishing services in wireless communications, comprising:
a memory;
at least one processor communicatively coupled with the memory, and the at least one processor operable to:
transmit, via the transceiver, a service request related to establishing a service over an established radio bearer;
detect an authentication failure for the service request;
determine whether a procedure related to the service request is successfully completed; and
determine whether to terminate the established radio bearer based at least in part on the determination of whether the procedure related to the service request is successfully completed.

12. The user equipment of claim 11, wherein the at least one processor and the memory are operable to determine whether to terminate the established radio bearer at least in part by determining whether to start a service request retransmission timer after expiration of which the established radio bearer is terminated.

13. The user equipment of claim 12, wherein the at least one processor and the memory are operable to determine whether to start the service request retransmission timer based on an expiration of an authentication failure timer initialized based on detecting the authentication failure.

14. The user equipment of claim 13, wherein the at least one processor and the memory are operable to determine whether to start the service request retransmission timer at least in part by determining not to start the service request retransmission timer based on the expiration of the authentication failure timer where it is determined that the procedure related to the service request is successfully completed.

15. The user equipment of claim 13, wherein the at least one processor and the memory are operable to determine whether to start the service request retransmission timer at least in part by determining to start the service request retransmission timer based on the expiration of the authentication failure timer where it is determined that the procedure related to the service request is not successfully completed.

16. The user equipment of claim 13, wherein the at least one processor and the memory are operable to determine whether the procedure related to the service request is successfully completed at least in part by determining whether the procedure related to the service request is successfully completed before the expiration of the authentication failure timer.

17. The user equipment of claim 13, wherein the service request retransmission timer is a T3417 timer in third generation partnership project (3GPP) long term evolution (LTE) related to retransmission of the service request.

18. The user equipment of claim 11, wherein the at least one processor and the memory are operable to detect the authentication failure for the service request at least in part by detecting a message authentication code failure, a synchronization failure, or an authentication unacceptable error when attempting to authenticate the service request.

19. The user equipment of claim 11, wherein the procedure related to the service request comprises establishing the service over the established radio bearer.

20. The user equipment of claim 11, wherein the procedure relates to establishing an emergency service, and wherein the service request is for the emergency service.

21. A user equipment for establishing services in wireless communications, comprising:
means for transmitting a service request related to establishing a service over an established radio bearer;
means for detecting an authentication failure for the service request;
means for determining whether a procedure related to the service request is successfully completed; and
means for determining whether to terminate the established radio bearer based at least in part on the determination of whether the procedure related to the service request is successfully completed.

22. The user equipment of claim 21, wherein the means for determining whether to terminate the established radio bearer determines whether to terminate the established radio bearer based at least in part on determining whether to start a service request retransmission timer after expiration of which the established radio bearer is terminated.

23. The user equipment of claim 22, wherein the means for determining whether to start the service request retransmission timer determines whether to start the service request retransmission timer based on an expiration of an authentication failure timer initialized based on the means for detecting the authentication failure detecting the authentication failure.

24. The user equipment of claim 23, wherein the means for determining whether to start the service request retransmission timer determines not to start the service request retransmission timer based on the expiration of the authentication failure timer where it is determined that the procedure related to the service request is successfully completed.

25. The user equipment of claim 23, wherein the means for determining whether to start the service request retransmission timer determines to start the service request retransmission timer based on the expiration of the authentication failure timer where it is determined that the procedure related to the service request is not successfully completed.

26. A non-transitory computer-readable storage medium comprising computer-executable code for establishing services in wireless communications, the code comprising:
code for transmitting a service request related to establishing a service over an established radio bearer;
code for detecting an authentication failure for the service request;
code for determining whether a procedure related to the service request is successfully completed; and
code for determining whether to terminate the established radio bearer based at least in part on the determination of whether the procedure related to the service request is successfully completed.

27. The non-transitory computer-readable storage medium of claim 26, wherein the code for determining whether to terminate the established radio bearer determines whether to terminate the established radio bearer based at least in part on determining whether to start a service request retransmission timer after expiration of which the established radio bearer is terminated.

28. The non-transitory computer-readable storage medium of claim 27, wherein the code for determining whether to start the service request retransmission timer determines whether to start the service request retransmission timer based on an expiration of an authentication failure timer initialized based on the code for detecting the authentication failure detecting the authentication failure.

29. The non-transitory computer-readable storage medium of claim 28, wherein the code for determining whether to start the service request retransmission timer determines not to start the service request retransmission timer based on the expiration of the authentication failure timer where it is determined that the procedure related to the service request is successfully completed.

30. The non-transitory computer-readable storage medium of claim 28, wherein the code for determining whether to start the service request retransmission timer determines to start the service request retransmission timer based on the expiration of the authentication failure timer where it is determined that the procedure related to the service request is not successfully completed.
